(19) United States
(12) Patent Application Publication
(10) Pub. No.: US 2021/0372901 A1
(43) Pub. Date: Dec. 2, 2021

(54) WEIGHING STRUCTURE AND ADSORBED GAS MEASURING EQUIPMENT

(71) Applicant: Southwest Petroleum University, Chengdu (CN)

(72) Inventors: Shuyong Hu, Chengdu (CN); Tingting Qiu, Chengdu (CN); Boning Zhang, Chengdu (CN); Jiatie Zhang, Chengdu (CN); Xindong Wang, Chengdu (CN); Wenhai Huang, Chengdu (CN)

(21) Appl. No.: 17/099,824

(22) Filed: Nov. 17, 2020

(30) Foreign Application Priority Data
May 29, 2020 (CN) 2020104779301

(51) Int. Cl. G01N 5/02; G01G 19/52

(52) U.S. Cl. CPC G01N 5/02; G01G 19/52

(57) ABSTRACT

The disclosure provides a weighing structure and adsorbed gas measuring equipment, and belongs to the field of gas detection. The weighing structure comprises a mounting plate connected with a balance, a plurality of mounting rings and lifting devices, a plurality of mounting holes are formed in the mounting plate, and the upper portions of the mounting rings pass through the mounting holes; the lower portions of the mounting rings are provided with suspension wires for hoisting mounted objects, the mounting holes are in clearance fit with the mounting rings, and the lifting devices provide upward supporting force for the mounting rings. The measuring equipment further comprises a kettle body, and a cavity for accommodating the weighing structure and a support for supporting the balance are arranged in the kettle body, wherein weights or a sample cylinder are/is arranged at the lower ends of the suspension wires, and a heating layer and a gas injection nozzle are arranged outside the kettle body. According to the disclosure, the problem of inaccurate weighing caused by a weighing structure in the prior art is solved.

### TECHNICAL FIELD

The invention relates to the field of gas detection equipment, and more specifically to a weighing structure and adsorbed gas measuring equipment.

### BACKGROUND

Coal bed gas and shale gas are used as an unconventional natural gas garden, are rich in resources and huge in development potential, and are high-quality clean energy. The coal bed gas and shale gas mainly exist in reservoirs in a free state and an adsorbed state, wherein the content of adsorbed gas is a key parameter for calculating the resource quantity of the coal bed gas and the shale gas, and has important significance in reservoir gas content evaluation, geological reserves and recoverable reserves prediction.

A device and a method for measuring high-temperature and high-pressure isothermal adsorption by a gravimetric method in CN108458947A; a blank experiment, a buoyancy experiment, an adsorption experiment and the like are performed; weight measurement is compared with the actual weight of weights under incompatible temperature and pressure to obtain the influence caused by the temperature and the pressure; and the weight of the adsorbed gas is obtained by simulating the weight difference between a sample cylinder before adsorption and a sample cylinder after adsorption under isothermal and isobaric conditions, and then the content of the adsorbed gas is obtained.

Wherein, the weight measurement under various conditions is the key point of each experiment. However, the influence of temperature and pressure and the measurement and calculation of numerical values such as weight difference both depend on a high-precision weighing system. Besides an accurate weighing balance, a reasonable weighing structure is further needed. The contact between shifting forks and suspension wires is easy to cause inaccurate measurement results.

### SUMMARY

Aiming at the defects in the prior art, the disclosure provides a weighing structure and adsorbed gas measuring equipment comprising the weighing structure, and the problem of inaccurate weighing caused by the weighing structure in the prior art is solved.

The disclosure provides a weighing structure comprising a mounting plate connected with a balance, a plurality of mounting rings and lifting devices, a plurality of mounting holes are formed in the mounting plate, and the upper portions of the mounting rings pass through the mounting holes; the lower portions of the mounting rings are provided with suspension wires for hoisting mounted objects, the mounting holes are in clearance fit with the mounting rings, and the lifting devices provide upward supporting force for the mounting rings. The disclosure also provides adsorbed gas measuring equipment comprising the structure, the adsorbed gas measuring equipment further comprises a kettle body, and a cavity for accommodating the weighing structure and a support for supporting the balance are arranged in the kettle body, wherein weights or a sample cylinder are/is arranged at the lower ends of the suspension wires, and a heating layer and a gas injection nozzle are arranged outside the kettle body.

Compared with the prior art, the invention has the following beneficial effects: a mounting hook is replaced by the mounting plate, so that the mounting space is increased, and meanwhile, the mounting is more stable; the mounting rings are matched with the lifting devices, so that the mounting rings can be in contact with the mounting holes to be stressed or are not stressed, and then selective mounting is completed, and the purpose of measuring the weights and the sample cylinder respectively is achieved. Wherein, the lifting devices provide upward supporting force for the mounting rings, so that when the mounting plate is stressed, the lifting devices continue to descend, the lifting devices are not stressed any more, and measured data are not affected. The weighing structure is snatched with a heating layer of the kettle body for heat preservation, and the gas injection nozzle is added with gas or vacuumized to complete experiments under various simulation conditions.

### BRIEF DESCRIPTION OF THE DRAWINGS

FIG. 1 is a cross-sectional view of the overall structure of an embodiment of the disclosure.

FIG. 2 is a side view of a weighing structure.

FIG. 3 is a front view of a mounting ring.

In the figures, 1 is a kettle body, 2 is a cavity, 3 is a balance, 4 is a heating layer, 5 is a weighing structure, 6 is a sample cylinder, 51 is a mounting plate, 52 is a mounting hole, 53 is a mounting ring, 54 is a side column, 55 is a lifting rod, 56 is a sleeve hole, 57 is a suspension wire, and 58 is a motor.

### DESCRIPTION OF THE EMBODIMENTS

The technical scheme of the disclosure is further described in conjunction with the following drawings and embodiments.

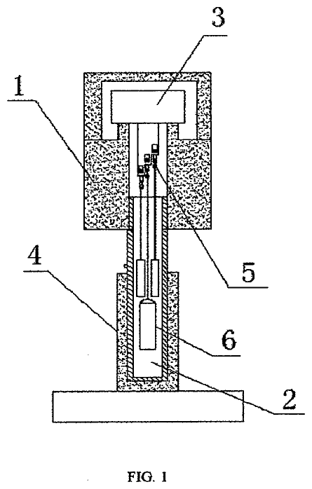

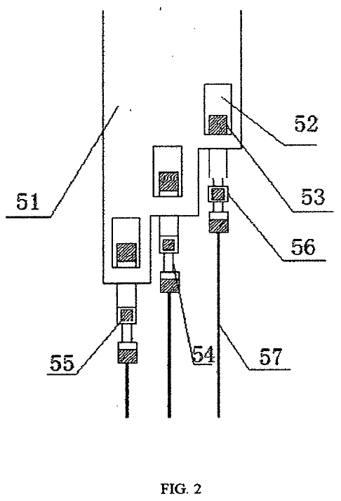

As shown in FIG. 1, the disclosure provides a weighing structure comprising a mounting plate 51 connected with a balance 3, a plurality of mounting rings 53 and lifting devices, a plurality of mounting holes 52 are formed in the mounting plate 51, and the upper portions of the mounting rings 53 pass through the mounting holes 52; the lower portions of the mounting rings 53 are provided with suspension wires 57 for hoisting mounted objects, the mounting holes 52 are in clearance fit with the mounting rings 53, and the lifting devices provide upward supporting force for the mounting rings 53. The lifting devices are in the lifting ranges of the positions where the mounting rings 53 are matched with the bottoms of the mounting holes 52. The mounting plate 51 is equivalent to a hanging hook of the balance 3 and is arranged in the form of the mounting plate 51, so that a plurality of mounting holes 52 are formed, and the purpose that a plurality of mounting rings 53 have respective positions and do not interfere with one another is achieved. The mounting holes 52 are arranged side by side or in a staggered mode along the width direction of the mounting plate 51. In actual calculation, due to the fact that the positions of the mounting holes 52 are different, force bearing points of the lever principle are also different, and the force bearing points are considered in a measurement result through a preset program. The purpose of the side-by-side arrangement is to prevent mutual interference between the suspension wires 57. Of course, as shown in FIG. 2, the mounting holes 52 can also be arranged in the staggered mode, and the mounting holes 52 do not coincide in the vertical direction. The side-by-side arrangement can result in thinner walls between the mounting holes 52, and the staggered arrangement can be of thicker sidewalls which are relatively firm.

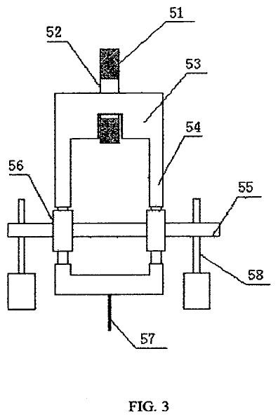

As shown in FIG. 3, each mounting ring 53 comprises vertical side columns 54, the cross sections of the upper portions of the side columns 54 are larger than those of the lower portions of the side columns 54, and each lifting device comprises a lifting rod 55 and motors 58 which are arranged at the two ends of the lifting rod 55 and drive the lifting rod 55 to ascend and descend; sleeve holes 56 matched with the lower portions of the side columns 54 are formed in the lifting rod 55, and the cross sections of the sleeve holes 56 are smaller than those of the upper portions of the side columns 54. The lifting rod 55 and the motors 58 can ascend or descend through lead screw structures, and other common ascending and descending modes can also be adopted. The cross sections of the sleeve holes 56 are smaller than the upper portions of the side columns 54, and when the lifting rod 55 ascends, the sleeve holes 56 jack up the mounting rings 53 through the side columns 54; when the lifting rod 55 descends, the mounting rings 53 descend along with the lifting rod 55 due to the influence of gravity at the beginning, when the mounting rings 53 are in contact with the bottoms of the mounting holes 52 and the lifting rod 55 continues to descend, the sleeve holes 56 are in clearance fit with the lower portion of the lifting rod 55, and the mounting rings 53 do not make contact with the lifting rod 55 any more. Mounting is completely borne by the mounting plate 51, the lifting devices do not affect mounting any more, and measured data are accurate. In order to enable ascending and descending to be more stable, the number of the side columns 54 is two, and the two sleeve holes 56 are formed in the lifting rod 55 and matched with the two side columns 54 respectively. Meanwhile, the sleeve rings always sleeve the side columns 54, so that the phenomenon of unhooking caused by shaking during transportation and the like is avoided, and the failure rate of the equipment is low.

Based on the weighing structure 5, the disclosure further provides adsorbed gas measuring equipment further comprises a kettle body 1, a cavity 2 for accommodating the weighing structure and a support for supporting the balance 3 are arranged in the kettle body 1, weights or a sample cylinder 6 are/is arranged at the lower ends of the suspension wires 57, and a heating layer 4 and a gas injection nozzle are arranged outside the kettle body 1. The kettle body 1 is used for guaranteeing a simulation environment, the gas injection nozzle is used for injecting gas and vacuumizing, and the heating layer 4 is used for heating so as to simulate the influence of various temperatures and pressures on weighing. Furthermore, the heating layer 4 sleeves the lower portion of the kettle body 1, and the kettle body 1 is internally provided with a temperature detection device. The sample cylinder 6 and the weights are positioned at the lower portion of the cavity 2 of the kettle body 1, and the heating layer 4 is arranged at the lower part, so that the part is better guaranteed. Correspondingly, the experiment needs to measure the three target objects of the weight I, the weight II and the sample cylinder 6 for multiple times, so that three mounting holes 52 are needed.

In working hours, the lifting rod 55 corresponding to the mounting ring 53 needing to be weighed descends, and after the mounting ring 53 makes contact with the mounting hole 52, the lifting rod 55 continues to descend by a certain distance until the lifting rod 55 is not stressed at all, and the lifting rods 55 corresponding to other mounting rings 53 are not changed. When switching is needed, the lifting rod 55 corresponding to the weighed mounting ascends, the lifting rod 55 continues to advance upwards by a certain distance after being stressed until the mounting plate 51 is not stressed at all, and then the lifting rod 55 at the next weighing position is put down. As shown in FIG. 2, the leftmost weight is weighed at the position. The motors 58 are fixed on the inner wall of the cavity 2 or extend out of the support portion for fixed connection.

Finally, it is noted that the above-mentioned embodiments are only used for illustrating the technical scheme of the disclosure but not restricting the scope of protection of the disclosure; and although the disclosure is described in detail by reference to a better embodiment, those ordinary skilled in the art should understand that the technical scheme of the disclosure can be amended or equally substituted but not departing from the purpose and scope of the technical scheme of the disclosure and should be contained in the scope of claims of the disclosure.

What is claimed is:

1. A weighing structure, characterized by comprising a mounting plate connected with a balance, a plurality of mounting rings and lifting devices, wherein a plurality of mounting holes are formed in the mounting plate, and the upper portions of the mounting rings pass through the mounting holes; the lower portions of the mounting rings are provided with suspension wires for hoisting mounted objects, the mounting holes are in clearance fit with the mounting rings, and the lifting devices provide upward supporting force for the mounting rings.

2. The weighing structure according to claim 1, characterized in that the mounting holes are arranged side by side or in a staggered mode along the width direction of the mounting plate.

3. The weighing structure according to claim 2, characterized in that each mounting ring comprises vertical side columns, the cross sections of the upper portions of the side columns are larger than those of the lower portions of the side columns, and each lifting device comprises a lifting rod and motors which are arranged at the two ends of the lifting rod and drive the lifting rod to ascend and descend; sleeve holes matched with the lower portions of the side columns are formed in the lifting rod, and the cross sections of the sleeve holes are smaller than those of the upper portions of the side columns.

4. The weighing structure according to claim 3, characterized in that the mounting ring is in frame shapes, the number of the side columns is two, and two sleeve holes matched with the two side columns are formed in the lifting rod respectively.

5. Adsorbed gas measuring equipment, characterized by comprising the weighing structure according to any one of claims 1 to 4, wherein the equipment further comprises a kettle body, a cavity for accommodating the weighing structure and a support for supporting the balance are arranged in the kettle body, weights or a sample cylinder are/is arranged at the lower ends of the suspension wires, and a heating layer and a gas injection nozzle are arranged outside the kettle body.

6. The adsorbed gas measuring equipment according to claim 5, characterized in that the heating layer sleeves the lower portion of the kettle body, and the kettle body is internally provided with a temperature detection device.

7. The adsorbed gas measuring equipment according to claim 6, characterized in that the numbers of the mounting rings and the mounting holes are both three.
